(19) United States
(12) Patent Application Publication
(10) Pub. No.: US 2026/0184647 A1
(43) Pub. Date: Jul. 2, 2026

(54) LIQUID FERTILIZER COMPRISING NITROGEN, MAGNESIUM, AND CHLORIDE, AND METHODS FOR MAKING AND USING THE SAME

(71) Applicant: Growth Technologies, LLC, Grand Island, NE (US)

(72) Inventor: Marcus J. Dennis, York, NE (US)

(21) Appl. No.: 19/461,533

(22) Filed: Jan. 27, 2026

Related U.S. Application Data
(63) Continuation-in-part of application No. 18/733,212, filed on Jun. 4, 2024.
Application No. 18/733,212 is a continuation-in-part of application No. PCT/US22/80951, filed on Dec. 5, 2022.
(60) Provisional application No. 63/286,076, filed on Dec. 5, 2021.
(60) Provisional application No. 63/605,685, filed on Dec. 4, 2023.

(51) Int. Cl. C05C 9/00; C05C 1/00; C05C 3/00; C05D 1/00; C05D 9/02; C05F 11/02; C05G 5/20

(52) U.S. Cl. CPC C05C 9/00; C05D 9/02; C05G 5/20

(57) ABSTRACT

A liquid composition for use as a fertilizer is provided, the liquid composition comprising a hydrated complex of MgCl₂ and urea. The hydrated complex of MgCl₂ and urea may also serve as a base matrix for potassium, phosphorus, or sulfur containing fertilizers. Methods for making and using the same are also provided.

### CROSS REFERENCE TO RELATED APPLICATIONS

This application is a continuation-in-part of U.S. patent application Ser. No. 18/733,212, filed Jun. 4, 2024, which is a continuation in part of International Application No. PCT/US2022/080951, filed on Dec. 5, 2022, which claims the benefit of U.S. Provisional Patent Application No. 63/286,076, filed on Dec. 5, 2021. U.S. patent application Ser. No. 18/733,212 also claims the benefit of U.S. Provisional Patent Application No. 63/605,685, filed on Dec. 4, 2023. Each of these applications is incorporated by reference herein in its entirety.

### BACKGROUND

Plant life depends on sunlight to give the plant the energy it needs to grow and produce seed or fruit. Through the process of photosynthesis, plants convert sunlight into energy, and this energy is used to promote vegetative growth and plant reproduction. Any plant nutrient or combination of nutrients that encourages the efficiency of the photosynthetic process may give an advantage in plant health and yield.

Chlorophyll is the green pigment present in all green plants and is responsible for the absorption of sunlight that contributes to photosynthesis. In the corn plant, for example, several key nutrients are involved in the formation and production of chlorophyll. Nitrogen (particularly in the form of urea and ammonium nitrate) and other nutrients such as magnesium and molybdenum optimize the production of chlorophyll.

The lack of availability of these nutrients to plants is a persistent problem.

While urea is water soluble, it precipitates or “salts out” at relatively high temperatures and cannot be re-solublized. For example, urea 46-0-0 can be used to make urea solutions up to 47.82% by weight, a grade of 21-0-0 nitrogen solution, but has a salt out temperature of 38° F. Liquid fertilizer that sits in aboveground storage tanks through a cold winter can undergo stratification, salting out, or both. Stratification results in pockets of varying product concentrations within an aboveground storage tank. With cold temperatures, some liquid fertilizers will salt out, leaving a combination of salted product and liquid product. The salted product can clog sprayers, planters, and applicators.

Moreover, contacting magnesium chloride with nitrogen-containing fertilizers, e.g., 10-34-0 (ammonium polyphosphate) and 12-0-0-26 (ammonium thiosulfate), typically causes precipitation. Thus far, nitrogen and magnesium have been successfully combined in very low nitrogen concentrations (e.g., NutriMag™ 5 N-0 P-0 K-5.5 Mg manufactured by Innovative Surface Solutions) and/or including less advantageous forms of nitrogen (e.g., ammonium and nitrate, such as in 32-0-0 liquid).

Recent developments, disclosed in International Patent Application Publication No. WO2023102572A1, have provided a single fertilizer solution, comprising both high urea-based nitrogen concentration and chloride (Cl⁻) and magnesium (Mg²⁺) ions, that can be stored and applied using conventional storage and application apparatuses as a liquid at relatively cold (0° C. and below) ambient temperatures. The fertilizer solution has now proven suitable as a base matrix for other nutrients (e.g., potassium, phosphorus, or sulfur) as well.

### SUMMARY

In one aspect, a liquid composition (known as “N-Mag” or “Nitro-Mag”) for use as a fertilizer is provided, the liquid composition produced by the steps in the order: (1) providing an about 30% aqueous solution of magnesium chloride and heating the solution to a temperature of at least about 45° C.; (2) providing dry urea 46-0-0 and adding the dry urea 46-0-0 to the heated aqueous solution of magnesium chloride to form a solid-liquid mixture; (3) agitating the solid-liquid mixture to dissolve the dry urea 46-0-0 and form the liquid composition, wherein the liquid composition is characterized in that: (i) it remains in liquid form for more than 24 hours at a temperature of less than 0° C.; (ii) it has a pH between 7 and 8; and (iii) it has a fertilizer ratio of about 24N-0P-0K-0S-4 Mg-10Cl-0.035B. In one aspect, the 30% aqueous solution of magnesium chloride is provided in about 49% w/w, and the dry urea 46-0-0 is provided in about 51% w/w. In one aspect, the liquid composition further comprises fulvic acid. In one aspect, molybdenum, boron, zinc, manganese, and other trace elements can be added to the Nitro-Mag products as needed.

In another aspect, molybdenum may be added to the Nitro-Mag composition for use as a fertilizer. The molybdenum may be added in the proportion of, e.g., 2.5 gallons of 16% molybdenum per 5,000 gallons of liquid composition. In a further aspect, the molybdenum may be added so that the liquid composition comprises 2 oz/acre of molybdenum when the liquid composition is applied to crops.

In one aspect, the Nitro-Mag complex is neutrally charged. In one aspect, the Nitro-Mag complex has a molecular ratio of 12-18 mols of urea nitrogen to 1 mol magnesium. In one aspect, the molecular ratio of the Nitro-Mag complex can vary depending on the end use.

In another aspect, a method for preparing a liquid composition for use as a fertilizer is provided, the method comprising the steps in the order: (1) providing an about 30% aqueous solution of magnesium chloride and heating the solution to a temperature of at least about 45° C.; (2) providing dry urea 46-0-0 and adding the dry urea 46-0-0 to the heated aqueous solution of magnesium chloride to form a solid-liquid mixture; (3) agitating the solid-liquid mixture to dissolve the dry urea 46-0-0 and form the liquid composition, wherein the liquid composition is characterized in that: (i) it remains in liquid form for more than 24 hours at a temperature of less than 0° C.; (ii) it has a pH between 7 and 8; and (iii) it has a fertilizer ratio of about 24N-0P-0K-0S-4 Mg-10Cl-0.035B. In one aspect, the 30% aqueous solution of magnesium chloride is provided in about 49% w/w, and the dry urea 46-0-0 is provided in about 51% w/w, although other grade ratios can be made by varying the amounts of each component. In one aspect, the method further comprises providing fulvic acid.

In another aspect, a liquid composition is provided, the liquid composition prepared by mixing urea liquid at about 155° F. directly with MgCl₂ and, optionally, dry urea. In one aspect, the fertilizer grade ratio thus prepared was an about 20N-0-0-0-3 Mg ratio plus chloride and boron. In another aspect, the fertilizer grade ratio thus prepared was an about 23.5N-0-0-0-3 Mg ratio plus chloride and boron. In one aspect, the urea liquid has a concentration of either 50% or 70%. In one aspect, the heat from the urea liquid melts the dry urea. In one aspect, sulfur can be added to the mixture. In one aspect, different forms of potassium can be added to the mixture.

### BRIEF DESCRIPTION OF THE FIGURES

FIG. 1 is a flow chart showing the steps of the method that lead to the Nitro-Mag compositions comprising a complex of magnesium chloride and urea with mild hydration.

FIG. 2 is an example plant set-up for carrying out the steps of the method that lead to the Nitro-Mag compositions.

FIG. 3 shows the FTIR spectrum of urea.

FIG. 4 shows the TGA profile for urea.

FIG. 5 shows the FTIR spectra of MgCl₂·XH₂O and MgCl₂·2H₂O.

FIGS. 6A and 6B show the TGA spectra of MgCl₂·XH₂O and MgCl₂·2H₂O.

FIG. 7 shows the FTIR spectra of: (i) an example Nitro-Mag complex of magnesium chloride and urea with mild hydration; (ii) Nitro-Mag crystallized at 40° C.; and (iii) Nitro-Mag crystallized at 60° C.

FIGS. 8A and 8B show the TGA spectra of Nitro-Mag and Nitro-Mag crystallized at 60° C.

FIG. 9 shows mass data for several molecular formulae.

FIG. 10 shows the FTIR spectra of Nitro-Mag compared to two simple solutions of MgCl₂ and urea.

FIG. 11 shows TGA spectra of Nitro-Mag compared to two simple solutions of MgCl₂ and urea, in solution.

FIG. 12 shows TGA spectra of crystals formed from Nitro-Mag compared to crystals formed from two simple solutions of MgCl₂ and urea.

FIG. 13A shows a typical result when ammonium thiosulfate is contacted with magnesium chloride. FIG. 13B shows the result when ammonium thiosulfate is mixed with Nitro-Mag.

### DETAILED DESCRIPTION

The term “about” in conjunction with a number is simply shorthand and is intended to include ±10% of the number. This is true whether “about” is modifying a stand-alone number or modifying a number at either or both ends of a range of numbers. In other words, “about 10” means from 9 to 11. Likewise, “about 10 to about 20” contemplates 9 to 22 and 11 to 18. In the absence of the term “about,” the exact number is intended. In other words, “10” means 10. The term “about,” as applied to a fertilizer ratio, means that each present element (that is, each element that is present in a non-zero amount) of the ratio is intended to include ±10% of the number. For example, “about 24N-0P-0K-0S-4 Mg-10Cl-0.035B” means 24±10% N-0P-0K-0S-4±10% Mg-10±10% Cl-0.035±10% B.

In one aspect, a liquid composition for use as a fertilizer is provided, the liquid composition produced by the steps in the order: (1) providing an about 30% aqueous solution of magnesium chloride and heating the solution to a temperature of at least about 45° C.; (2) providing dry urea 46-0-0 and adding the dry urea 46-0-0 to the heated aqueous solution of magnesium chloride to form a solid-liquid mixture; (3) agitating the solid-liquid mixture to dissolve the dry urea 46-0-0 and form the liquid composition, wherein the liquid composition is characterized in that: (i) it remains in liquid form for more than 24 hours at a temperature of less than 0° C.; (ii) it has a pH between 7 and 8; and (iii) it has a fertilizer ratio of about 24N-0P-0K-0S-4 Mg-10Cl-0.035B. In one aspect, the 30% aqueous solution of magnesium chloride is provided in about 49% w/w, and the dry urea 46-0-0 is provided in about 51% w/w. In one aspect, the liquid composition further comprises fulvic acid.

In one aspect, the Nitro-Mag complex is neutrally charged. In one aspect, the Nitro-Mag complex has a molecular ratio of 12-18 mols of urea nitrogen to 1 mol magnesium.

In another aspect, the liquid composition further comprises molybdenum. In one aspect, the molybdenum may comprise, e.g., 2.5 gallons of 16% molybdenum per 5,000 gallons of liquid composition. In a further aspect, the molybdenum may be added so that the liquid composition comprises 2 oz/acre of molybdenum when the liquid composition is applied to crops.

In another aspect, a method for preparing a liquid composition for use as a fertilizer is provided, the method comprising the steps in the order: (1) providing an about 30% aqueous solution of magnesium chloride and heating the solution to a temperature of at least about 45° C.; (2) providing dry urea 46-0-0 and adding the dry urea 46-0-0 to the heated aqueous solution of magnesium chloride to form a solid-liquid mixture; (3) agitating the solid-liquid mixture to dissolve the dry urea 46-0-0 and form the liquid composition, wherein the liquid composition is characterized in that: (i) it remains in liquid form for more than 24 hours at a temperature of less than 0° C.; (ii) it has a pH between 7 and 8; and (iii) it has a fertilizer ratio of about 24N-0P-0K-0S-4 Mg-10Cl-0.035B. In one aspect, the 30% aqueous solution of magnesium chloride is provided in about 49% w/w, and the dry urea 46-0-0 is provided in about 51% w/w, although other grade ratios can be made by varying the amounts of each component. In one aspect, the method further comprises providing fulvic acid.

In one aspect, the product is not simply a mixture or super-saturated mixture of the two starting products. Rather, the liquid composition comprises a complex of MgCl₂ and urea (U) with mild hydration. In one aspect, the structure comprises MgCl₂U₄·XH₂O, wherein X=1 to 6.

Urea, also known as carbamide, is an organic compound having the chemical formula CO(NH₂)₂. Urea 46-0-0, or urea 46% nitrogen, is a white crystalline solid containing 46% nitrogen. Urea 46-0-0 is widely used in the agriculture industry as a fertilizer. The designation “46-0-0” refers to a fertilizer ratio, in this case, an NPK (nitrogen-phosphorus-potassium) fertilizer ratio of 46 N:0 P:0 K. “Fertilizer ratio” means the ratio of two or more nutrients to another in 100 pounds of material.

Urea is readily commercially available or may be manufactured by feeding ammonia and carbon dioxide into a reactor at 180-210° C. and 150 bar pressure. After stripping the reaction mixture of ammonia, the urea solution is concentrated by evaporation or crystallization.

MgCl₂ is also commercially available, typically in the form of MgCl₂·6H₂O crystals. Water is added to the crystals to achieve a desired concentration. For example, for a 30% MgCl₂ solution, 14.88 lbs of MgCl₂·6H₂O are mixed per gallon of water.

Molybdenum (Mo) is also commercially available, typically in the form of molybdenum trioxide (MoO₃). Boron, zinc, and other micronutrients can be added, as well.

### EXAMPLES

### Example 1: Preparation and Characterization of MgCl₂U₄·XH₂O

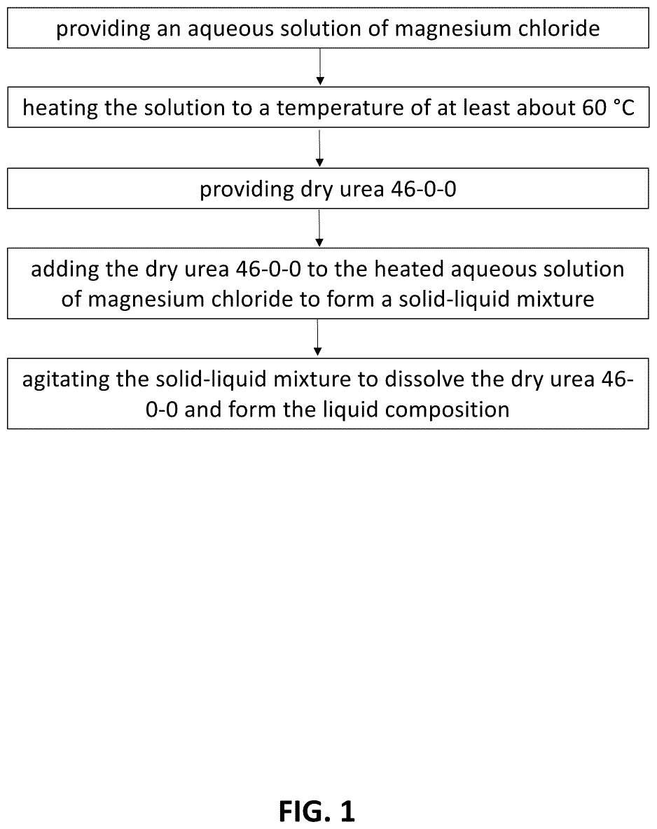

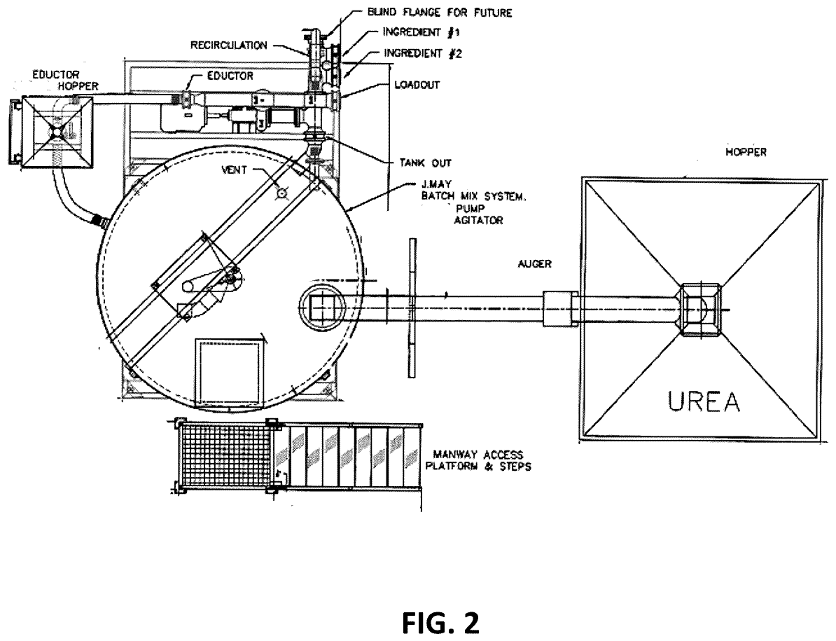

With reference to FIGS. 1 and 2, a 30% MgCl₂ solution (968 lbs), such as, for example obtained from Compass Minerals, sourced from the Great Salt Lake in Utah, is placed into a commercial fertilizer blender and heated to about 60° C. Granular urea 46-0-0 (1,008 lbs) (˜51% urea to ˜49% MgCl₂ w/w) is added slowly to the heated MgCl₂ solution by hopper with forceful agitation. 24 lbs of fulvic acid is also added. After the mixture becomes a homogeneous, slightly viscous, light brown liquid free of foreign matter, agitation is ceased, and the liquid is cooled and prepared for transport. The liquid product has a fertilizer ratio of about 24N-0P-0K-0S-4 Mg-10Cl-0.035B, a pH of about 7.5-7.8, and remains in liquid form below 0° C. for sustained periods.

The product (Nitro-Mag) was evaluated by:

### Fourier Transform Infrared (FTIR) Spectroscopy

Bruker Tensor II
MIRacleATR sampling accessory
4 cm⁻¹ resolution, 16 scans per spectrum, 4000-600 cm⁻¹

### Thermogravimetric Analysis (TGA)

TA Instruments, Hi-Res TGA 2950 Thermogravimetric Analyzer
30° C./minute ramp to 800° C.
Oxygen atmosphere

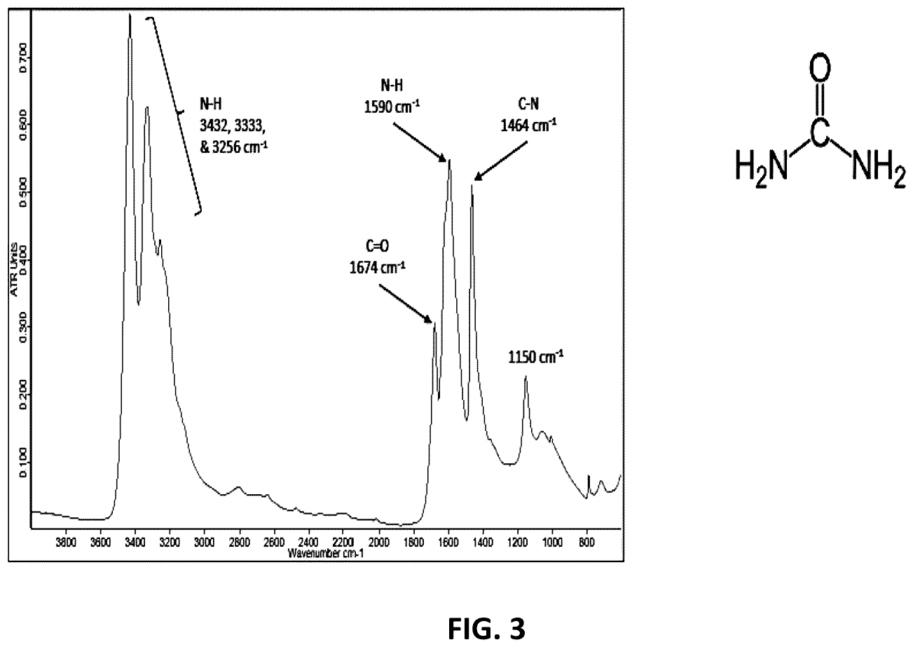

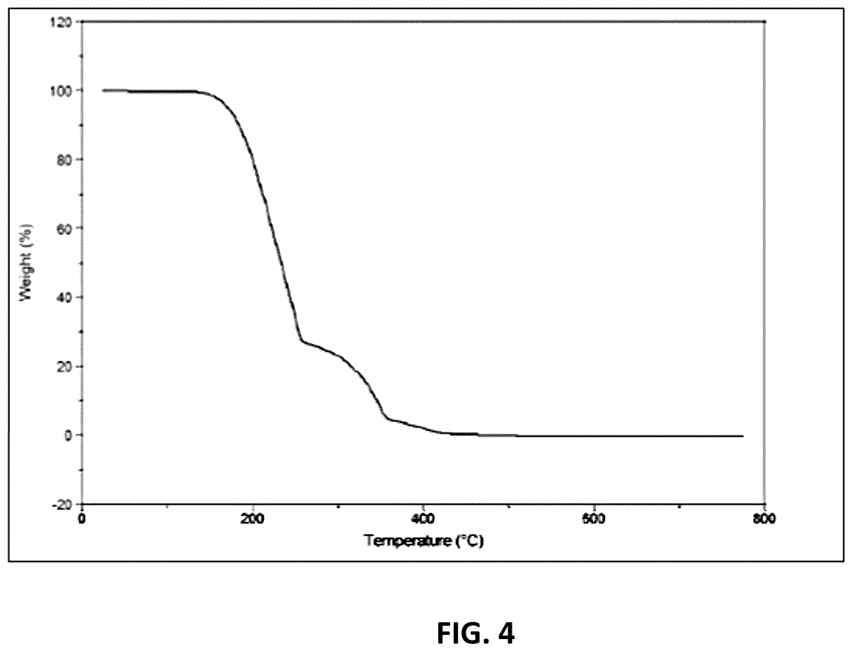

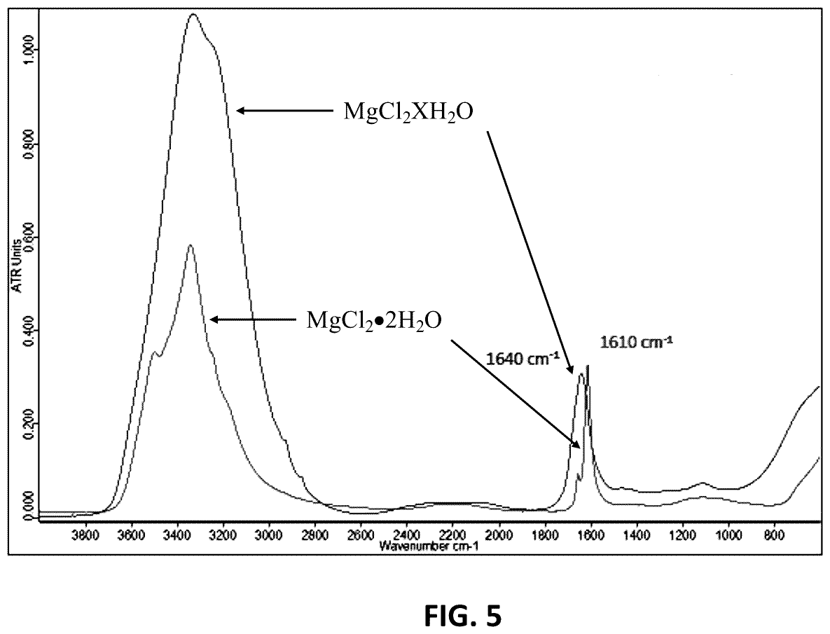

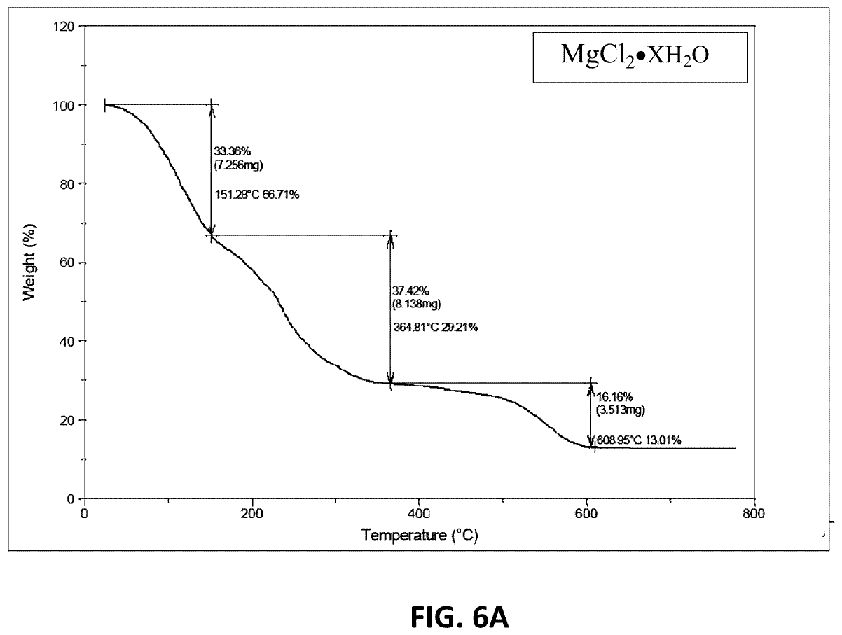

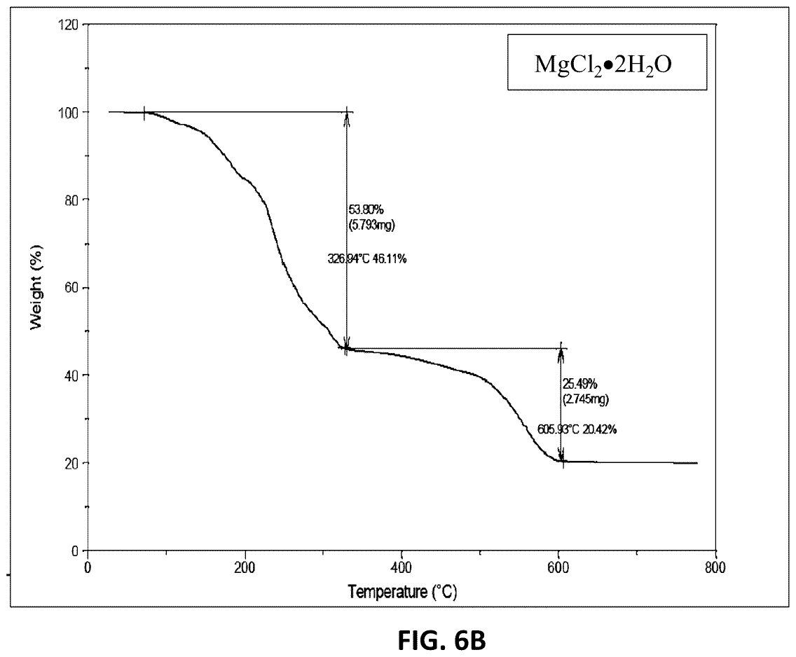

FIG. 3 shows the FTIR spectrum of urea. FIG. 4 shows the TGA profile for urea. FIG. 5 shows the FTIR spectra of MgCl₂·XH₂O and MgCl₂·2H₂O. FIGS. 6A and 6B show the TGA spectra of MgCl₂·XH₂O and MgCl₂·2H₂O.

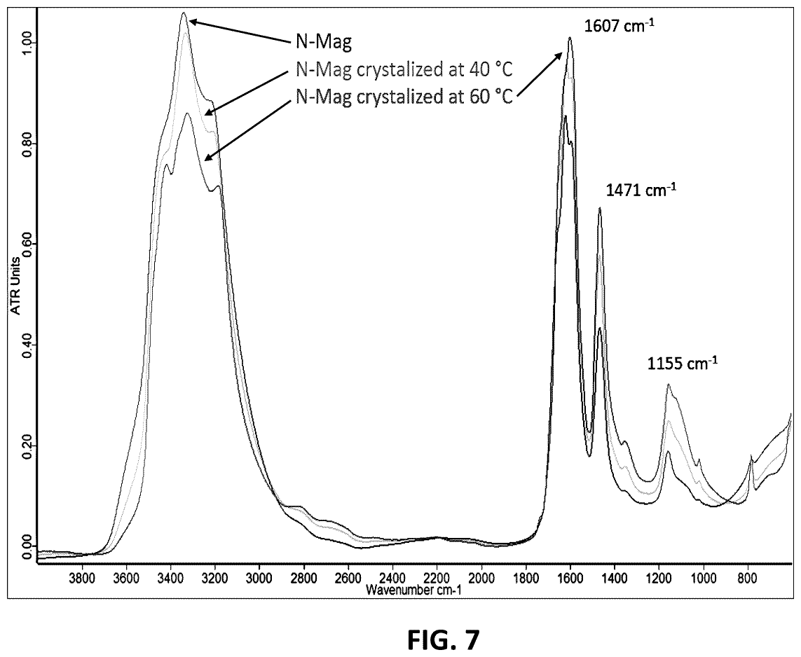

FIG. 7 shows the FTIR spectra of: (i) Nitro-Mag; (ii) Nitro-Mag crystallized at 40° C.; and (iii) Nitro-Mag crystallized at 60° C. Nitro-Mag is a combination of MgCl₂ and urea with features of both represented in the FTIR spectrum. As the product is dried and crystallized, there is a slight decrease in absorbance in the 3000-3600 cm⁻¹ region, indicating that the final product is mildly hydrated (in contrast to the MgCl₂·XH₂O starting product that shows more dramatic changes in this region as the product is dried).

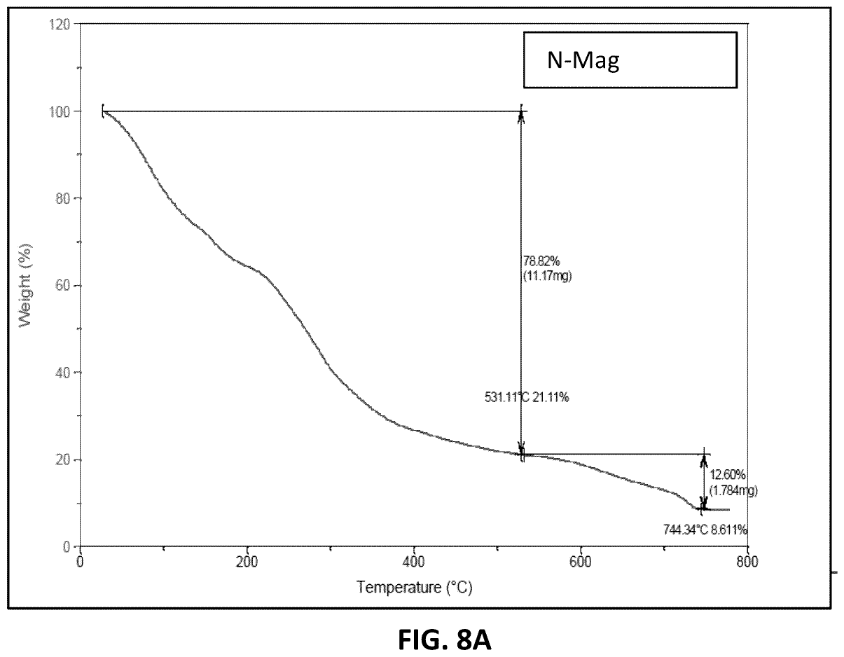

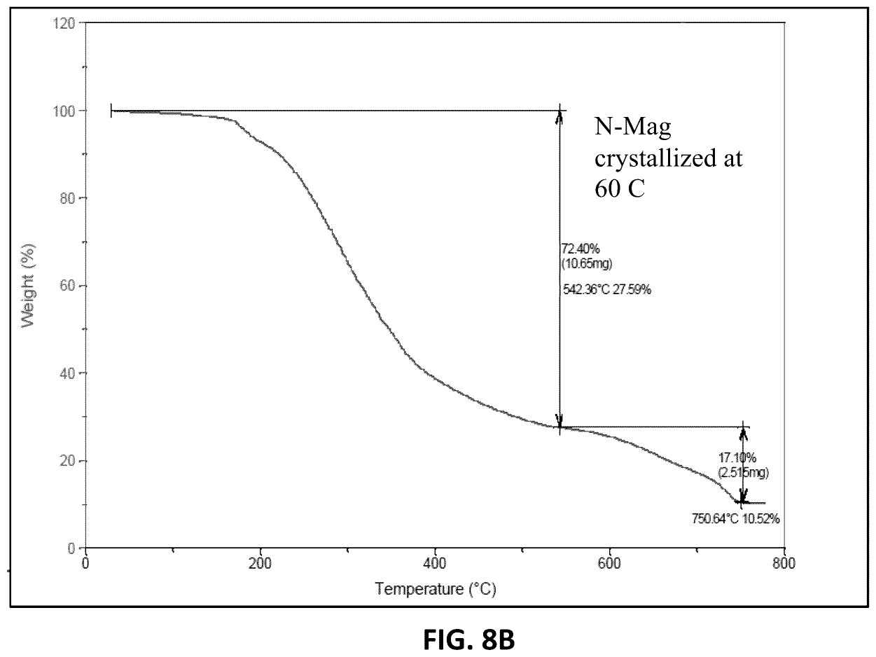

FIGS. 8A and 8B show the TGA spectra of Nitro-Mag and Nitro-Mag crystallized at 60° C. TGA of Nitro-Mag does not show clear transitions that can be correlated to fragmentation of the molecule. TGA of the dried sample, however, shows two transitions. Because the weight change does not begin until the temperature reaches almost 200° C., the initial weight loss is not attributed to water. If, instead, the mass loss of 72% is attributed to urea, a complex of MgCl₂U₄ would correlate to these data.

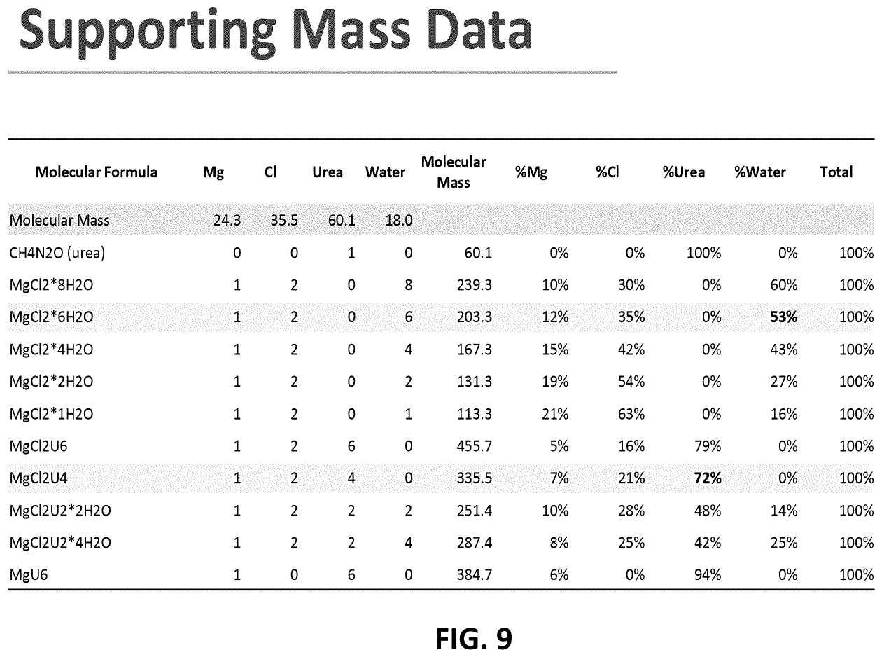

FIG. 9 shows mass data for several molecular formulae. In TGA, molecules rarely break down to the bare metal atom, Mg in this case. The residue is generally an oxide, like MgO, or salt, like MgCl₂. Therefore, the mass percent of Mg or Cl alone is unlikely to correlate to the final stages of TGA.

Nitro-Mag was next compared to simple mixtures of starting materials. First, MgCl₂ (49% w/w) and urea (51% w/w) were combined at room temperature and mixed thoroughly until homogeneous. Second, MgCl₂ was heated to 60° C. prior to the addition of urea.

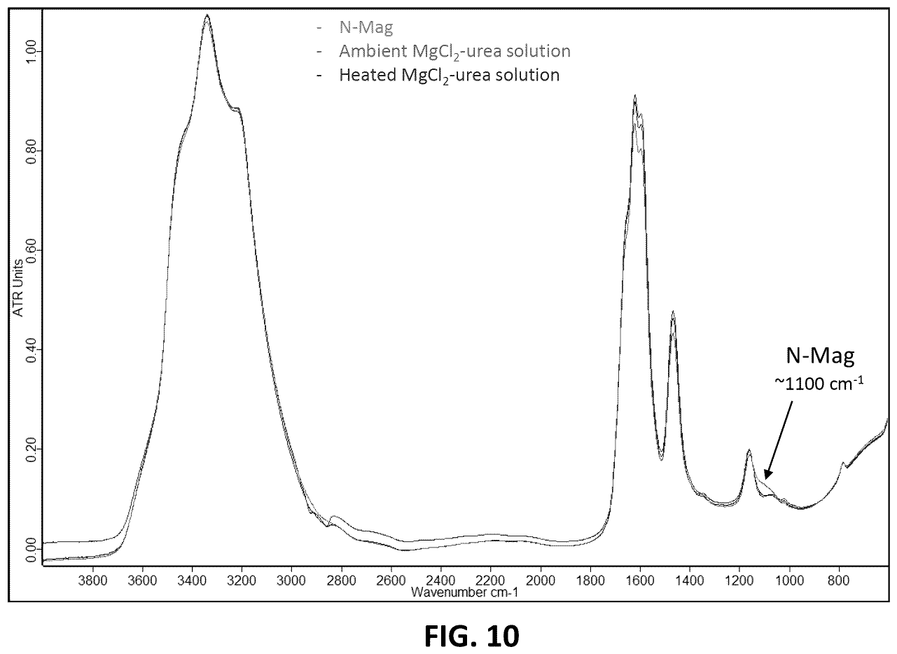

FIG. 10 shows the FTIR spectra of Nitro-Mag compared to the two simple solutions. FTIR spectra of the simple MgCl₂-urea solutions are very similar (the small baseline shift is not significant). When overlaid with the spectrum of the Nitro-Mag product, there is a distinctive absorbance around 1100 cm⁻¹ that is not present in the simple mixtures. This unique spectral feature supports that the Nitro-Mag is a new complex, not simply a mixture of the starting materials.

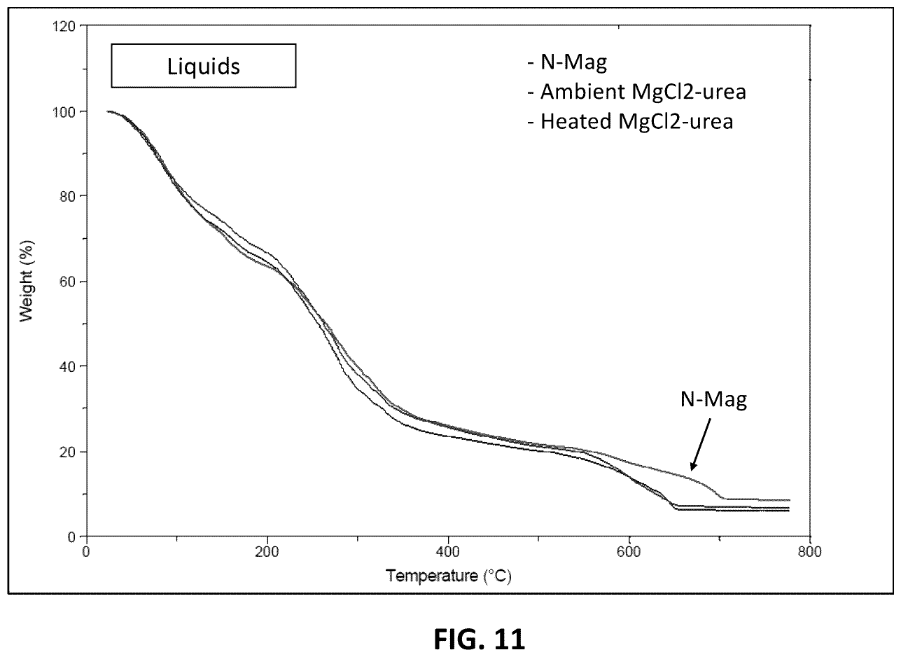

FIG. 11 shows TGA spectra of Nitro-Mag compared to the two simple solutions, in solution. TGA profiles of the simple solutions and Nitro-Mag are similar until temperatures exceed 550° C. Above 550° C., there is a distinctive shift in the profile for Nitro-Mag. This shift supports that the Nitro-Mag is a new complex, not simply a mixture of the starting materials.

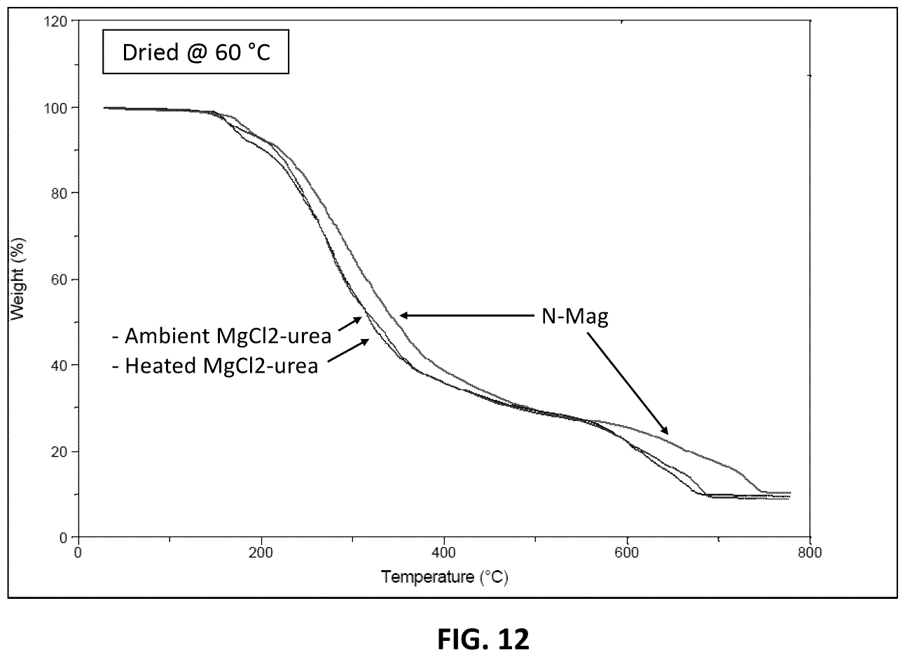

FIG. 12 shows TGA spectra of crystals formed from Nitro-Mag compared to the two simple solutions. Crystals formed from the simple mixtures produced very similar TGA profiles. There is a distinctive shift in the profile for the Nitro-Mag throughout the temperature ramp. This shift further supports that the Nitro-Mag crystals represent a new complex, not co-crystallization of the starting materials.

In one aspect, the Nitro-Mag complex is neutrally charged.

### Example 2: Fertility Test (Plot Scale)

The liquid composition (Nitro-Mag) from Example 1 was compared to other formulations and tested on corn as follows:

TABLE 1
Formulations

| Formulation No. | Formulation |
|---|---|
| 1 | Dry urea |
| 2 | Urea (first application) and 32-0-0 (liquid) |
| 3 | Urea (first application) and 28-0-0-5S (combination |
| | of 32-0-0 (10 ga.) and ammonium thiosulfate |
| | (12-0-0-26) (2 ga.) (both liquids)) |
| 4 | Urea (first application) and 32-0-0 (liquid) |
| | combined with 30% MgCl₂ solution (51:49 w/w) |
| 5 | Urea (first application) and 46-0-0 (solid) |
| | combined with 30% MgCl₂ solution (51:49 w/w) |
| | (Nitro-Mag) as described in Example 1 |
| 6 | Urea (first application) and 32-0-0 (liquid) |
| | combined with 30% MgCl₂ solution (51:49 w/w), |
| | plus nitrogen stabilizer |
| 7 | Urea (first application) and 46-0-0 (solid) |
| | combined with 30% MgCl₂ solution (51:49 w/w) |
| | (Nitro-Mag) as described in Example 1, plus |
| | nitrogen stabilizer |

TABLE 2
Application Method

| Application | |
|---|---|
| Method No. | Application Method |
| 1 | 250 lb N (dry urea) spread between rows (“up front”) |
| 2 | 150 lb N (dry urea) up front; with corn at approximately |
| | 1 ft., 50 lb N [according to Formulation No.] along the |
| | sides of the corn in the rows (“by side-dress”); with |
| | corn at approximately 4-5 ft., 50 lb N [according to |
| | Formulation No.] along the sides of the corn in the |
| | rows (“by y-drop”) |

TABLE 3
Plot* Results

| | Formulation | Application | | Avg |
|---|---|---|---|---|
| Row | No. | Method No. | Bu./Acre | Bu./Acre |
| 1 | 1 | 1 | 233 | 242 |
| 2 | 1 | 1 | 229 | |
| 3 | 1 | 1 | 263 | |
| 4 | 1 | 1 | 244 | |
| 1 | 2 | 2 | 242 | 252 |
| 2 | 2 | 2 | 241 | |
| 3 | 2 | 2 | 261 | |
| 4 | 2 | 2 | 264 | |
| 1 | 3 | 2 | 271 | 269 |
| 2 | 3 | 2 | 271 | |
| 3 | 3 | 2 | 263 | |
| 4 | 3 | 2 | 273 | |
| 1 | 4 | 2 | 271 | 270 |
| 2 | 4 | 2 | 263 | |
| 3 | 4 | 2 | 272 | |
| 4 | 4 | 2 | 273 | |
| 1 | 5 | 2 | 281 | 291 |
| 2 | 5 | 2 | 301 | |
| 3 | 5 | 2 | 284 | |
| 4 | 5 | 2 | 296 | |
| 1 | 6 | 2 | 280 | 272 |
| 2 | 6 | 2 | 275 | |
| 3 | 6 | 2 | 268 | |
| 4 | 6 | 2 | 264 | |
| 1 | 7 | 2 | 280 | 291 |
| 2 | 7 | 2 | 301 | |
| 3 | 7 | 2 | 292 | |
| 4 | 7 | 2 | 291 | |

*Plot size: 4 rows, 47.5 ft/per row, 30″ between rows

As shown in Table 3, Nitro-Mag (Formulation Nos. 5 and 7) resulted in consistent, significant increases over urea alone (20%) and the other nitrogen-containing blends (7-15%).

Molybdenum may be added to the Nitro-Mag formulations in the ratio of, for example, 2.5 gallons of 16% molybdenum per 5,000 gallons of liquid composition.

### Example 3: Fertility Tests (Field Scale)

Formulation No. 5 (Nitro-Mag) was tested on #2 yellow corn at 10 test sites. Four test sites were evaluated for yield results, plant health, stock quality, and nutrient uptake during different corn plant growth stages. Six test sites were evaluated only for yield results.

Trial #1: The first trial with Nitro-Mag was side dressed (fertilizer put in the ground by the root) on corn at the V5 leaf stage. The comparison was done against regular 32% nitrogen. The test fields were visited weekly throughout the summer to observe the different stages of growth and how they compared to one another. The roots were healthy and well established. The ears on the Nitro-Mag and 32% nitrogen-treated corn both filled all the way to the end and had similar girth and length. Toward the end of summer, Nitro-Mag-treated plants were a darker color of green compared to the 32% nitrogen-treated plants. The darker green indicates that the Nitro-Mag plant was healthier. For plant health, healthy chlorophyll molecules mean healthier corn leaves and more productive photosynthesis, which results in better stock health, nutrient uptake, and higher yields. The yield results validated the visual inspections: on an equal nitrogen basis, Nitro-Mag had a five bushel/acre advantage over the 32% nitrogen.

Trial #2: The Nitro-Mag was applied through Y-Drop (product sprayed on the ground, right beside where the corn plant emerges from the ground) on corn at the V8 stage. The plants had a very strong green color. On an equal nitrogen basis, Nitro-Mag had a 4.5 bushel/acre advantage over the 32% nitrogen.

Trial #3: The Nitro-Mag was applied by fertigation (fertilizer was applied through irrigation pivots during watering) over two applications, pre-tassel and post-pollination. The plant and stock health were consistent throughout the season. This trial was a comparison between 28-0-0-5 and Nitro-Mag. The products were applied at the exact same time with the same amount of nitrogen. Both sides of the field were equally healthy and the ears on both sides had very comparable length and girth. The Nitro-Mag yielded nine bushels/acre more than the 28-0-0-5. Stock quality was monitored throughout the trial, and the Nitro-Mag had a very health pith (inside of the corn stalk), while the 28-0-05 showed signs of stock rot.

Trial #4: This trial between Nitro-Mag and ammonia was delayed due to rain and should have been applied sooner, which could have provided higher yields. The Nitro-Mag was applied once by fertigation at brown silk, and the plant and stock health were very good. Nitro-Mag showed a four bushel/acre yield increase.

Trial #5: One side of the test area had 32% nitrogen plus Humic and 2 gallons of MgCl₂. With the MgCl₂ added, that drops the 32% to 30%, or 3.3 # of nitrogen per gallon. The variable rate side dress application was between 30 and 35 gallons of 30% nitrogen mix. The same number of gallons were applied on the Nitro-Mag side. The 30% side had between 99 to 115 lbs of N per acre applied. The Nitro-Mag side had between 78 to 91 lbs of amine nitrogen per acre applied (i.e., roughly 24 lbs less nitrogen with Nitro-Mag). The 30% fertilizer mix made 289 bushels/acre at 15% moisture. The Nitro-Mag side made 298 bushels/acre at 15% moisture, representing a 9 bushel/acre yield increase on 30 lbs less nitrogen.

Trial #6: One pass was Nitro-Mag 337.5 bushels/acre vs 328.6 bushels/acre for the 32%=8.9 bushels/acre advantage. Another was Nitro-Mag 332.2 bushels/acre vs 326.3 bushels/acre for the 32%=5.9 bushels/acre advantage. One-time application as Y Drop on the Brevant number was Nitro-Mag 316 bushels/acre vs 311 bushels/acre for the 32%=5 bushels/acre advantage.

Trial #7: In side-by-side field tests of Nitro-Mag compared to the typical 32%, Nitro-Mag yielded 246 bushels/acre vs 231 bushels/acre for the 32%.

Trial #8: In side-by-side field tests of Nitro-Mag compared to the typical 32%, Nitro-Mag yielded a 12 bushels/acre advantage compared to the 32%.

Trial #9: In side-by-side field tests of Nitro-Mag compared to the typical 32%, Nitro-Mag yielded a 16 bushels/acre advantage compared to the 32%.

Trial #10: In side-by-side field tests of Nitro-Mag compared to the typical 32%, Nitro-Mag yielded a 13 bushels/acre advantage compared to the 32%.

### Example 4: Stability Tests

Nitro-Mag from Example 1 was compared to other formulations and tested for temperature resistance:

| | Salt-out at 0° C.? |
|---|---|
| Formulation | (S/O temp, if measured) |
| 46-0-0 (solid) combined with | No salt-out, even |
| 30% MgCl₂ solution (51:49 | after 24 hours |
| w/w) (Nitro-Mag) | |
| 46-0-0 solution in water | Salted-out at 15° C. |
| (50/50 wt/wt) | |

### Example 5: Nitro-Mag as Base Matrix #1; Nitro-Mag Plus Potassium (Nitro-Mag-K)

### Nitro-Mag-K v.1: 19N-0P-3K-0S-3 Mg-7Cl-0.25B

The addition of potassium to Nitro-Mag improves Nitro-Mag's efficiency for late season pivot applications and for use on other crops that require more potassium. The base matrix is Nitro-Mag, which is blended back with dry soluble potash (0-0-60) ((i.e., put back in the blender and remixed with water and soluble potash in the correct amounts) as a re-blended mix to formulate a 19N-0P-3K-0S-3 Mg-7Cl-0.25B liquid product.

The same blend can be manufactured at the time the Nitro-Mag is being made, by adding the correct amount of soluble potash to the other products used to formulate Nitro-Mag liquid.

For back blending of Nitro-Mag with soluble potash, the formula is: 80% Nitro-Mag+15-20% H2O+5.3% Soluble Potash (0-0-60).

The amount of water may have to be increased if temperatures are colder. For example, at 20 lbs of water, potassium settles out of the mix. In warmer temperatures, 15 lbs will float the potassium.

Roughly a ton of Nitro-Mag-K v.1 product includes:

$$Nitro - Mag 80 \# \times 20 = 1600 lbs$$

$$Water @ 15 \# \times 20 = 300 lbs$$

$$Potash @ 5.3 \# \times 20 = 100 lbs$$

$$Total amount = 2000 lbs$$

Making the Nitro-Mag-K v.1 product with this method permits existing Nitro-Mag to be taken out of storage and blended in a timely fashion for delivery to, e.g., a farm, avoiding long term storage of the product. If long term storage is required, the water may be increased to 400 lbs in a ton batch. The Nitro-Mag-K v.1 can be cold blended with the proper agitation and adding the water first.

For blending Nitro-Mag-K v.1 from scratch:
Nutri-Boost added at desired level
Magnesium Chloride 39% or 19,500 lbs in a 50,000 lb load.
Urea (46-0-0) 41% or 20,500 lbs in 50,000 lbs
Water at 15% or 7500 # in 50,000 lbs
Soluble Potash (0-0-60) 5.3% or 2,650 lbs in 50,000 lb

### Mixing Instructions:

Nutri-Boost liquid stabilizer is added to the reactor first at the desired amount (e.g., 600 lbs).
Place 19,500 pounds of MgCl₂ in the reactor to heat to 60-70° C.
Place 7,500 lbs of H₂O to the blend, continuing to heat and agitate.

Once the correct temperatures have been achieved, add 20,500 lbs of dry urea (46-0-0) to the mix while agitating.

As the mixture blends and a heat of at least 110° F. is maintained, add in the 2,650 lbs of dry soluble potassium (0-0-60). Continue to agitate until product is blended.

These instructions produce a 19 N-0 P-3 K-0 S-3 Mg-7Cl-0.25B mix of Nitro-Mag-K v.1. The Nitro-Mag-K v.1 product weighs 10.9 pounds per gallon.

### Example 6: Nitro-Mag as Base Matrix #2; Various Blends as Corn Starters or Liquid Phosphate Category of Products

Other than liquid nitrogen 32% and side dressing products such as 28-0-0-5S, the highest usage of liquid fertility products is in the corn starter or liquid phosphate category of products. The most widely used phosphate product is a polyphosphate known as 10-34-0. In 100 pounds of product, 10-34-0 contains ten pounds of nitrogen and 34 pounds of phosphate. 10-34-0 is made by reacting a 68% phosphoric acid with anhydrous ammonia in an exothermic reaction.

Unfortunately, the combination of MgCl₂ with 10-34-0 product precipitates, resulting in clogged hoses and solids that must be removed from the bottom of large tanks.

Surprisingly, however, a stable phosphate source (e.g., 54% Merchant Grade Acid) and Nitro-Mag mix suitably with MgCl₂. Three such blends were prepared:

10-30-0

For a 10-30-0 blend, pump in the desired amount of 54% Merchant Grade Phosphoric Acid into a tank or tanker transport in a 55% ratio of the final gallon quantity needed. If blending a 4,500 gallon batch, 55% of those 4,500 gallons would be the phosphoric acid, or 2,475 gallons.

The next step is to back blend in the Nitro-Mag liquid by pumping it into the tank or tanker to freely mix with the 54% Phosphoric Acid. In this case, that would be 2,025 gallons or 45% of the blend with the Nitro-Mag liquid fertilizer.

The end result is a 10N-30P-0K-0S-3 Mg-5Cl+Boron product.

### 20-10-0 Blend

For the 20-10-0 blend, the same procedure is followed, except that the ratios of the two reagents will change due to the different amounts of nutrients desired. To make a 4,500 gallon batch, first introduce the 54% Phosphoric Acid by pumping 18% of the phosphoric acid or 810 gallons into the tank.

The next step is to back blend in the Nitro-Mag liquid at 82% of the 4,500 gallons, or 3,690 gallons.

The end result is a 20N-10P-0K-0S-4 Mg-7Cl+Boron product.

### 17-15-0 Blend

For the 17-15-0 blend, the same procedure may be used. Start by taking 28% Phosphoric Acid or 1,260 gallons of a 4,500 gallon batch and pumping it into the tank.

The next step is to back blend 72% or 3,240 gallons of Nitro-Mag into the same tank, letting it blend freely.

The end result is a 17N-15P-0K-0S-3.5 Mg-6Cl+Boron product.

The success of these blends is based on the ability of 54% Merchant Grade Phosphoric Acid to blend well with MgCl₂ in the presence of the Nitro-Mag base matrix.

### Example 7: Nitro-Mag as Base Matrix #3; Various Blends as Corn Starters or Liquid Phosphate Category of Products

To make a ton of 20N-12P-0K-0S-3.2 Mg-9Cl-.29B configuration:
(1) Add 1,680 # of Nitro-Mag in the reactor while agitating.
(2) Add in 320 # of a 75% Phosphoric Green Acid and continue to blend until well mixed.

To make a ton of 10N-28P-0K-0S-1.7 Mg-4.6Cl-0.15B configuration:
(1) Add 840 # of Nitro-Mag into the reactor with agitation and heat.
(2) Add 740 # of 75% Phosphoric Green Acid and continue to agitate and heat.
(3) Add 420 #water to the mix and continue to blend until well mixed.
(4) Heating temperatures on this blend should be at 38° C.

### Example 8: Nitro-Mag as Base Matrix #4; Various Blends as Corn Starters or Liquid Phosphate Category of Products

To make a ton of 20N-12P-0K-0S-3.2 Mg-9Cl-0.29B:
(1) Add Nutri-Boost Stabilizer at 25 # or more to the reactor.
(2) Add 811 # of MgCl₂ into the reactor while mixing and heating.
(3) Add 320 # of 75% Phosphoric Acid while mixing and heating to 60-70° C.
(4) Add 844 # of Urea to melt while continuing to mix until all solids are blended.
(5) If final product has unsuitably thick viscosity, up to 300 # of water may be added per ton.

To blend a ton of 10-28-0K-0S-1.6 Mg-4.6Cl-0.15B
(1) Add 25 # or more of Nutri-Boost Stabilizer to the reactor.
(2) Add 400 # of MgCl₂ into the reactor while mixing and heating the product.
(3) Add 740 # of 75% Phosphoric Acid while mixing and heating to 60-70° C.
(4) Add 420 # of water while mixing and heating.
(5) Add 415 # of urea to melt while continuing to mix until all solids are blended.

### Example 9: Nitro-Mag as Base Matrix #5; Various Blends Using “32% N”

### Nitro-Mag-K v.2: 20N-0P-3K-0 S-2 Mg-5Cl-0.017B

(1) Add 796 lbs of Nitro-Mag to reactor;
(2) Add 700 lbs of 32% Nitrogen (50% Urea (NH₂), 25% Ammonium (NH₄+), and 25% Nitrate (NO₃⁻))
(3) Heat to 90-100° F.
(4) Add 104 lbs of soluble Potash 0-0-60
(5) Add 400 lbs of H2O
(6) Blend until Potash is melted.

### Nitro-Mag-S: 25N-0P-0K-4S-2 Mg-5Cl-0.017B

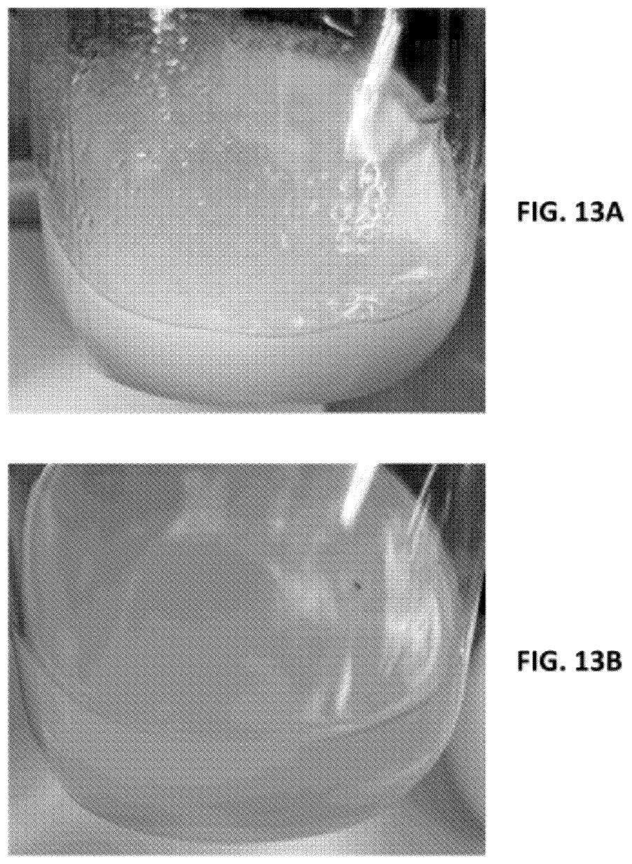

The Product Nitro-Mag S has ammonium thiosulfate in the blend, which typically has a reaction with magnesium chloride causing the product to fall out. FIG. 13A shows a typical result when ammonium thiosulfate is contacted with magnesium chloride. When mixed with the Nitro-Mag, the ammonium thiosulfate stays in suspension. FIG. 13B shows the result when ammonium thiosulfate is mixed with Nitro-Mag. These two products have never been able to be mixed until now. Nitro-Mag-S is blended as follows:
(1) Add 1000 lbs of Nitro-Mag to reactor
(2) Add 700 lbs of 32% N (50% Urea (NH₂), 25% Ammonium (NH₄+), and 25% Nitrate (NO₃⁻))
(3) No heat should be required for this mix
(4) Add 300 lbs of ammonium thiosulfate.

### Nitro-Mag KS: 20N-0P-3K-3S-2 Mg-5Cl-0.017B

(1) Add 796 lbs of Nitro-Mag to reactor
(2) Add 20 lbs of fulvic acid
(3) Add 255 lbs of water
(4) Add 579 lbs of 32% N (50% Urea (NH₂), 25% Ammonium (NH₄+), and 25% Nitrate (NO₃⁻))
(5) Heat to 110° F.
(6) Add 250 lbs of ammonium thiosulfate
(7) Add 100 lbs of soluble Potash 0-0-60, blend until dissolved

### Nitro-Mag 28: 28N-0P-0K-0S-2 Mg-5Cl-0.017B

(1) Add 1000 lbs of Nitro-Mag to blender
(2) Add 1000 lbs of 32% N (50% Urea (NH₂), 25% Ammonium (NH₄+), and 25% Nitrate (NO₃⁻))

Molybdenum may be added to the Nitro-Mag formulation in the ratio of, e.g., 2.5 gallons of 16% molybdenum per 5,000 gallons of liquid composition.

### Example 10: Nitro-Mag Quick Mix

As described in Example 1, Nitro-Mag may be produced by bringing the MgCl₂ into a large mixer or blender. The MgCl₂ may be heated to a temperature that can vary from 120 to 160° F. (approximately 45° C. to 65° C.). When the temperature of the MgCl₂ liquid has reached the desired temperature, dry urea may be slowly introduced with agitation. As the urea is introduced, it begins to melt due to the heat and the agitation. Various ratios and blends can be made by changing the percentages of MgCl₂ and the dry urea.

Once the urea is fully melted, the chemical complex is formed. Other Nitro-Mag blends and mixes can be cold blended, or the Nitro Mag reheated for the addition of 0-0-60 soluble Potassium, as described in Examples 5-9.

### Quik Mix Formulation and Production.

Nitro-Mag Quik Mix™ is an alternative fertilizer formulation having an efficacy similar to that of Nitro-Mag.

Urea liquor (UL) is part of the dry urea manufacturing process. UL comes in various percentages of amine nitrogen. As the name implies, UL is a liquid. Most common is a 50% UL. 50% UL comprises 23% amine nitrogen. 50% UL has a salt-out temperature of approximately 68° F. (19-20° C.). Thus, UL is typically loaded for transport at about 155° F. (62° C.).

Commercial fertility products generally are manufactured for the highest percentage of fertility that the solution or complex can hold. To this end, a 70% Urea Liquor product with 32% amine nitrogen is a preferred UL for the Quick Mix process.

The salt-out temperature of 70% UL is 132° F. (50-51° C.). The high salt-out temperature means that 70% UL will crystallize at or around 130° F. This can be problematic in handling and transportation. However, using an insulated tanker trailer with 70% UL loaded at 155 degrees in normal weather conditions, the UL will lose 5 degrees every 12 hours. That gives the product a fair mileage range for delivery.

Using the formation of Nitro-Mag as inspiration, the inventor hypothesized that the 70% UL could be mixed directly with the MgCl₂ at ambient temperature or after mild heating. By mixing heated UL directly with the MgCl₂ at a colder temperature, the chemical complex may be formed using the heat already available in the 70% UL. This saves the expense of having a boiler for preheating the MgCl₂ liquid to melt the dry urea.

The fertilizer grade ratio thus prepared was a 20N-0-0-0-3 Mg ratio plus chloride and boron.

This Quik Mix Nitro-Mag has a mol ratio of about 14 urea nitrogen to 1 Mg. This is sufficient to provide nitrogen stabilization in the soil as well as a reasonable cold salt-out temperature. This mix salted out at about 5° F.

To achieve this mix, 1300 # of 70% UL at 150° F. was pumped into 700 #MgCl₂ at 60° F. This was done on a pre-weighed amount of UL and MgCl₂ in a tanker trailer. The mixed product of Nitro Mag Quick Mix was measured at 130° F. (50° C.).

### Increasing the Fertility Grade Ratio.

Having established the Quik Mix method of Nitro-Mag manufacturing, the amount of amine nitrogen was increased in the formula. This was accomplished by adding about 20% dry urea to 35%/ton MgCl₂ to form a slurry. Optimally, the correct amount of urea and MgCl₂ can be added to a tanker trailer, and then 70% UL can be added into the tanker trailer (at 150 to 155° F.). The result is about 23.5N-0-0-0-3 Mg. This blend will finish melting the urea in the tanker. The complex has a mol ratio of approximately 15 urea N to 1 Mg. That is well within the range of the standardly produced Nitro-Mag with a 12-18 Urea N to 1 Mg depending on the mix. With the addition of the urea, the complex did not salt-out even at 0° C. Nitro-Mag produced in the standard process has the same salt-out characteristics.

The aspects disclosed herein are not intended to be exhaustive or to be limiting. A skilled artisan would acknowledge that other aspects or modifications to instant aspects can be made without departing from the spirit or scope of the invention. The aspects of the present disclosure, as generally described herein and illustrated in the figures, can be arranged, substituted, combined, separated, and designed in a wide variety of different configurations, all of which are contemplated herein.

Unless otherwise specified, “a,” “an,” “the,” “one or more of,” and “at least one” are used interchangeably. The singular forms “a”, “an,” and “the” are inclusive of their plural forms. The recitations of numerical ranges by endpoints include all numbers subsumed within that range (e.g., 1 to 5 includes 1, 1.5, 2, 2.75, 3, 3.80, 4, 5, etc.). The terms “comprising” and “including” are intended to be equivalent and open-ended. The phrase “consisting essentially of” means that the composition or method may include additional ingredients and/or steps, but only if the additional ingredients and/or steps do not materially alter the basic and novel characteristics of the claimed composition or method. The phrase “selected from the group consisting of” is meant to include mixtures of the listed group.

When reference is made to the term “each,” it is not meant to mean “each and every, without exception.”

What is claimed is:

1. A hydrated complex comprising magnesium chloride and urea, which in a crystalline form, has one or both of: (i) the Fourier transform infrared spectrum shown in FIG. 7; and (ii) the thermogravimetric analysis spectrum shown in FIG. 8A.

2. A liquid composition comprising the hydrated complex of claim 1, produced by the steps in the order:
(1) providing an about 30% aqueous solution of magnesium chloride and heating the solution to a temperature of at least 45° C.;
(2) providing dry urea 46-0-0 and adding the dry urea 46-0-0 to the heated aqueous solution of magnesium chloride to form a solid-liquid mixture;
(3) agitating the solid-liquid mixture to dissolve the dry urea 46-0-0 and form the liquid composition, wherein the liquid composition is characterized in that:
(i) it remains in liquid form for more than 24 hours at a temperature of less than 0° C.;
(ii) it has a pH between 7 and 8; and
(iii) it has a fertilizer ratio comprising about 20-24 N:0 P:0 K:3-4 Mg.

3. The liquid composition of claim 2, wherein the 30% aqueous solution of magnesium chloride is provided in about 49% w/w, and the dry urea 46-0-0 is provided in about 51% w/w.

4. The liquid composition of claim 2, wherein the 30% aqueous solution of magnesium chloride further comprises boron.

5. The liquid composition of claim 4, wherein the fertilizer ratio is about 24 N:0 P:0 K:4 Mg:10 Cl:0.35 B.

6. The liquid composition of claim 5, wherein the liquid composition further comprises molybdenum.

7. An enhanced liquid composition, the enhanced liquid composition formed by contacting the liquid composition of claim 5 with (i) 32% nitrogen comprising 50% urea, 25% ammonium, and 25% nitrate; (ii) soluble potash 0-0-60; and (iii) water, to form a fertilizer ratio of about 20 N:0 P:3 K:0 S:2 Mg:5 Cl:0.017 B.

8. An enhanced liquid composition, the enhanced liquid composition formed by contacting the liquid composition of claim 5 with (i) 32% nitrogen comprising 50% urea, 25% ammonium, and 25% nitrate; and (ii) ammonium thiosulfate, to form a fertilizer ratio of about 25 N:0P:0K:4 S:2 Mg:5 Cl:0.017 B.

9. An enhanced liquid composition, the enhanced liquid composition formed by contacting the liquid composition of claim 5 with (i) 32% nitrogen comprising 50% urea, 25% ammonium, and 25% nitrate; (ii) soluble potash 0-0-60; (iii) water; (iv) ammonium thiosulfate; and (v) fulvic acid, to form a fertilizer ratio of about 20 N:0 P:3 K:3 S:2 Mg:5 Cl:0.017 B.

10. An enhanced liquid composition, the enhanced liquid composition formed by contacting the liquid composition of claim 5 with 32% nitrogen comprising 50% urea, 25% ammonium, and 25% nitrate, to form a fertilizer ratio of about 28 N:0 P:0 K:0 S:2 Mg:5 Cl:0.017 B.

11. A method for preparing the liquid composition of claim 2, the method comprising the steps in the order:
(1) providing an about 30% aqueous solution of magnesium chloride and heating the solution to a temperature of at least 45° C.;
(2) providing dry urea 46-0-0 and adding the dry urea 46-0-0 to the heated aqueous solution of magnesium chloride to form a solid-liquid mixture; and
(3) agitating the solid-liquid mixture to dissolve the dry urea 46-0-0 and form the liquid composition.

12. A method for preparing the liquid composition of claim 2, the method comprising contacting 70% urea liquor at least about 60° C. with magnesium chloride in a wt/wt ratio of about 65/35.

13. The method of claim 12, further comprising contacting dry urea 46-0-0 in a wt/wt/wt ratio of about 54/29/17.
